(19) United States
(12) Patent Application Publication
(10) Pub. No.: US 2010/0076120 A1
(43) Pub. Date: Mar. 25, 2010

(54) METHOD OF CHANGING RHEOLOGY IN FILLED RESIN SYSTEMS USING CAVITATION

(75) Inventors: Gordon T. Emmerson, Los Alamitos, CA (US); David M. Shenfield, Fountain Valley, CA (US); Peter Saxton, Torrance, CA (US); Ihab Farid, Seal Beach, CA (US); Chih-Min Cheng, Westford, MA (US); Daniel J. Duffy, Somerville, NJ (US)

Correspondence Address: Henkel Corporation, 10 Finderne Avenue, Bridgewater, NJ, 08807, US

(73) Assignee: NATIONAL STARCH AND CHEMICAL INVESTMENT HOLDING CO, New Castle, DE (US)

(21) Appl. No.: 12/440,955

(22) PCT Filed: Sep. 6, 2007
(86) PCT No.: PCT/US2007/077734

§ 371 Date: Nov. 24, 2009

Related U.S. Application Data
(60) Provisional application No. 60/843,900, filed on Sep. 12, 2006.
(60) Provisional application No. 60/843,899, filed on Sep. 12, 2006.
(60) Provisional application No. 60/843,901, filed on Sep. 12, 2006.

(51) Int. Cl. C08F 6/00

(52) U.S. Cl. 524/1

(57) ABSTRACT

A particle filled resin system is produced by cavitation. A method of producing a filled resin system comprises providing a resin and a filler, and subjecting the resin and filler to cavitation. A method of changing the rheology of a filled resin system comprises subjecting the filled resin system to cavitation.

### BACKGROUND OF THE INVENTION

This invention relates to resin compositions filled with particles in which the filler particles are modified, mixed, or dispersed, or any combination of those processes, by high shear using cavitation.

Cavitation is a physical reaction of liquids under high shear that involves the formation of bubbles and cavities within the liquid stream resulting from a localized pressure drop and high velocity in the liquid flow. Under the proper conditions, the bubbles and cavities form, exist briefly, and collapse violently. The collapse process generates shockwaves that propagate through the liquid medium. The collapse of the bubbles is not symmetric and as a result jets of liquid are pulled through the collapse center and shoot out the other side. This intense and localized release of energy may be used to aid in chemical reactions, to mix and disperse materials, to reduce the particle size of materials, and to accomplish deagglomeration.

There are four principle types of cavitation: acoustic, in which pressure variations in the liquid are effected using ultrasound waves (16 KHz to 100 MHz); hydrodynamic cavitation, in which pressure variations are created by the passage of the liquid medium through a constriction, such as an orifice plate or venturi tubes, under controlled conditions; optic, in which photons of high intensity light rupture the liquid continuum; and particle, in which a beam of elementary particles ruptures the liquid. The underlying physical principle of bubble or cavity formation and collapse is the same for each. As the liquid is subjected to pressure variations, localized pressure drops occur. When the pressure drops to the vapor pressure of the liquid, cavities and bubbles form, which subsequently collapse when the pressure recovers downstream of the inception.

The tensile modulus of a liquid is the relevant mechanical property that impacts the cavitation process. Purified fluids have a very high tensile modulus and it is difficult to cavitate them by placing them under hydrostatic strain. However, the presence of dissolved gas in the liquid medium acts as a defect in the liquid continuum and provides a nucleation point for failure under strain, that is, cavitation. Most liquids have a finite amount of gas dissolved in them, for example, oxygen, nitrogen, carbon dioxide, and water vapor.

FIG. 1, frames 1 and 2 show a schematic pressure/volume/temperature diagram for a liquid and the associated transitions that correspond to the cavitation process. The three arrows shown in frames 1 and 2, from left to right, represent pressure drops of increasing magnitude. The pressure drop represented by the left arrow in frame 1 is not sufficient for a phase transition of the liquid to gas. The pressure drop represented by the center arrow brings the system to the vapor-liquid equilibrium fine, at which point vapor bubbles can form and cavitation can occur. The right arrow represents a transition of the liquid to a vapor.

Frame 2 presents the same system but with dissolved gas. The dashed line represents the point at which gas bubbles are observed in equilibrium with the fluid phase. The transition represented by the left arrow is now sufficient to produce a two-phase, gas-liquid equilibrium, the point at which cavitation can occur without the larger pressure drop required in frame 1. The pressure drops represented by center and right arrows in frame 2 are in excess of what is needed for cavitation and causes the liquid to boil or foam. Thus, dissolved gas can act as a defect point in the liquid continuum and can reduce the effective vapor-liquid equilibrium enabling cavitation at a smaller pressure drop.

Interfaces, such as liquid-liquid, liquid-solid, particles, and container walls, also act as regions at which the liquid system can relieve strain by cavitating. Topologically rough surfaces, low energy surfaces, and phase separated systems will enhance the probability of cavitation, as dissolved gasses localize near solid-liquid interfaces and interfaces of low surface energy.

Referring again to FIG. 1, frames 1 and 2, the inception of cavitation occurs as the minimum pressure in the system approaches the vapor pressure of the liquid medium. The total system pressure need not be reduced to the vapor pressure of the liquid. The motion of the fluid around an object or through a confined geometry creates spatially localized low pressure zones. It is the pressure drop within these zones that causes cavitation. The temperature dependence of cavitation is directly related to the temperature dependence of the vapor pressure of the liquid. The higher the vapor pressure of the liquid system, the higher the minimum pressure in the localized low pressure zones can be for cavitation to occur. The closer the minimum pressure of the system is to the vapor pressure, the more likely it is that cavitation (and not boiling or foaming) will occur.

It is easy to generate a cavitation flow in water because it has a high vapor pressure, high surface tension, low viscosity, and a high degree of gas solubility. Cavitation in organic liquids and high molecular weight liquids is difficult. Materials such as hexane have high vapor pressures, but low surface tensions, low boiling points, and low gas solubilities, producing boiling rather than cavitation during processing. In contrast, polymers, oligomers, and resins are not expected to cavitate because they have very low vapor pressure and their vapor pressure approaches zero as molecular weight increases.

### BRIEF DESCRIPTION OF THE DRAWING

FIG. 1, containing frames 1 and 2, gives depictions of a pressure/volume/temperature diagram for a liquid and the associated transitions that correspond to the cavitation process.

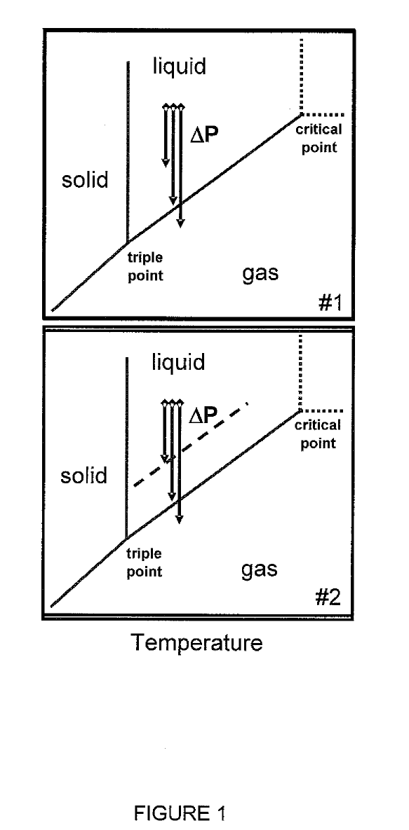

### SUMMARY OF THE INVENTION

It has now been discovered, unexpectedly, that cavitation can be used to produce filled resin systems comprising a resin (polymers, oligomers, monomers) and a filler. Resin means one or more resins and filler means one or more fillers. The fillers can be organic or inorganic, conductive or non-conductive, and can be in any size (for example, nano or micron) or shape, (for example, particles, powders, flakes or platelets). It has also been discovered, unexpectedly, that the rheology of these filled resin systems can be changed without varying the filler loading, when the resin and filler are mixed by cavitation.

When the filler has a high aspect ratio, for example, a layered material or an agglomeration of nano particles, cavitation peels off the layers or breaks up the agglomeration and the viscosity of the filled resin increases due to an increase in surface area of the filler material without any increase in total filler loading. This can be useful for those applications where a higher viscosity is needed, for example, in pastes, creams and the like, but the cost of the filler is high, or a high loading is otherwise undesired. Prior art processes for the dispersion of nano fillers in resin systems did not generate sufficient energy to de-aggomerate nano fillers.

When the filler has a low aspect ratio, cavitation causes a reduction in viscosity of the filled resin without any reduction in total filler loading. Thus, it is possible to attain a higher filler loading without a concomitant increase in viscosity for filled resin systems produced by cavitation than would be possible for filled resin systems that are not produced by cavitation. It is also possible to increase the filler loading without obtaining an increase in viscosity. This can be useful for those applications where a high filler content is needed, for example, in conductive materials to increase conductivity, but the lower viscosity is needed for dispensing.

Thus, this invention is a filled resin system produced by cavitation, and a method of producing a filled resin system comprising providing resin and filler, and subjecting the resin and filler to cavitation. In another embodiment, this invention is a method of changing the rheology of a filled resin system by subjecting the system to cavitation.

### DETAILED DESCRIPTION OF THE INVENTION

As used in this specification and claims, “cavitation”, “produced by cavitation” and like terms relating to cavitation, mean a process in which a material composition is subjected to a physical strain that causes localized drops in pressure that approach the vapor pressure of the composition, creating cavities that subsequently collapse when the pressure recovers, releasing energy and heat. This process is effected by the mechanics of cavitation processors that are commercially available.

As used in this specification and claims, filled resin system means a composition of organic monomers, oligomers, polymers, or a combination of any of these, loaded with a filler; filler means filler particles, filler flakes, or fillers in any form, which can be organic or inorganic, conductive or non-conductive.

Suitable resins for use in these systems include epoxies, maleimides (including bismaleimide), acrylates and methacrylates, and cyanate esters, vinyl ethers, thiol-enes, compounds that contain carbon to carbon double bonds attached to an aromatic ring and conjugated with the unsaturation in the aromatic ring (such as compounds derived from cinnamyl and styrenic starting compounds), fumarates and maleates. Other exemplary compounds include polyamides, phenoxy compounds, benzoxazines, polybenzoxazines, polyether sulfones, polyimides, siliconized olefins, polyolefins, polyesters, polystyrenes, polycarbonates, polypropylenes, poly(vinyl chloride)s, polyisobutylenes, polyacrylonitriles, poly(vinyl acetate)s, poly(2-vinylpyridine)s, cis-1,4-polyisoprenes, 3,4-polychloroprenes, vinyl copolymers, poly(ethylene oxide)s, poly(ethylene glycol)s, polyformaldehydes, polyacetaldehydes, poly(b-propiolacetone)s, poly(10-decanoate)s, poly(ethylene terephthalate)s, polycaprolactams, poly (11-undecanoamide)s, poly(m-phenylene-terephthalamide)s, poly(tetramethlyene-m-benzenesulfonamide)s, polyester polyarylates, poly(phenylene oxide)s, poly(phenylene sulfide)s, poly(sulfone)s, polyetherketones, polyetherimides, fluorinated polyimides, polyimide siloxanes, poly-isoindolo-quinazolinediones, polythioetherimide poly-phenyl-quinoxalines, polyquinixalones, imide-aryl ether phenylquinoxaline copolymers, polyquinoxalines, polybenzimidazoles, polybenzoxazoles, polynorbornenes, poly(arylene ethers), polysilanes, parylenes, benzocyclobutenes, hydroxyl-(benzoxazole) copolymers, and poly(silarylene siloxanes).

Suitable epoxy resins include, but are not limited to, bisphenol, naphthalene, and aliphatic type epoxies. Commercially available materials include bisphenol type epoxy resins (Epiclon 830LVP, 830CRP, 835LV, 850CRP) available from Dainippon Ink & Chemicals, Inc.; naphthalene type epoxy (Epiclon HP4032) available from Dainippon Ink & Chemicals, Inc.; aliphatic epoxy resins (Araldite CY179, 184, 192, 175, 179) available from Ciba Specialty Chemicals, (Epoxy 1234, 249, 206) available from Dow Corporation, and (EHPE-3150) available from Daicel Chemical Industries, Ltd. Other suitable epoxy resins include cycloaliphatic epoxy resins and dicyclopen-tadienephenol type epoxy resins.

Suitable cyanate ester resins include those having the generic structure

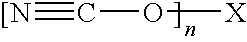

in which n is 1 or larger, and X is a hydrocarbon group. Exemplary X entities include, but are not limited to, bisphenol A, bisphenol F, bisphenol S, bisphenol E, bisphenol 0, phenol or cresol novolac, dicyclopentadiene, polybutadiene, polycarbonate, polyurethane, polyether, or polyester. Commercially available cyanate ester materials include; AroCy L-10, AroCy XU366, AroCy XU371, AroCy XU378, XU71787.02L, and XU 71787.07L, available from Huntsman LLC; Primaset PT30, Primaset PT30 S75, Primaset PT60, Primaset PT60S, Primaset BADCY, Primaset DA230S, Primaset MethylCy, and Primaset LECY, available from Lonza Group Limited; 2-allyphenol cyanate ester, 4-methoxyphenol cyanate ester, 2,2-bis(4-cyanatophenol)-1,1,1,3,3,3-hexafluoropropane, bisphenol A cyanate ester, diallylbisphenol A cyanate ester, 4-phenylphenol cyanate ester, 1,1,1-tris(4-cyanatophenyl)ethane, 4-cumylphenol cyanate ester, 1,1-bis(4-cyanatophenyl)ethane, 2,2,3,4,4,5,5,6,6,7,7-dodecafluoro-octanediol dicyanate ester, and 4,4′-bisphenol cyanate ester, available from Oakwood Products, Inc.

Other suitable cyanate esters include cyanate esters having the structure:

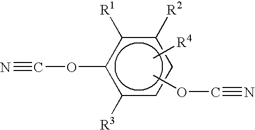

in which R¹ to R⁴ independently are hydrogen, C₁-C₁₀ alkyl, C₃-C₈ cycloalkyl, C₁-C₁₀ alkoxy, halogen, phenyl, phenoxy, and partially or fully fluorinated alkyl or aryl groups (an example is phenylene-1,3-dicyanate), or another cyanate ester group.

cyanate esters having the structure:

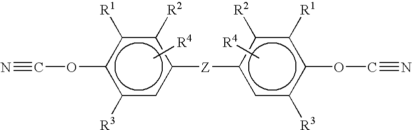

in which R¹ to R⁴ independently are hydrogen, C₁-C₁₀ alkyl, C₃-C₈ cycloalkyl, C₁-C₁₀ alkoxy, halogen, phenyl, phenoxy, and partially or fully fluorinated alkyl or aryl groups; Z is a chemical bond or SO₂, CF₂, CH₂, CHF, CHCH₃, isopropyl, hexafluoroisopropyl, C₁-C₁₀ alkyl, O, N═N, R⁸C═CR⁸ (in which R⁸ is H, C₁ to C₁₀ alkyl, or an aryl group), R⁸COO, R⁸C═N, R⁸C═N—C(R⁸)═N, C₁-C₁₀ alkoxy, S, Si(CH₃)₂ or one of the following structures:

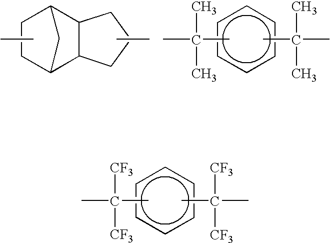

(an example is 4,4′ ethylidenebisphenylene cyanate having the commercial name AroCy L-10 from Vantico);

cyanate esters having the structure:

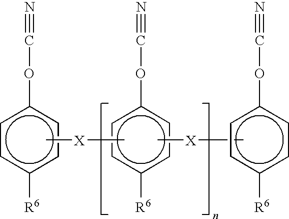

in which R⁶ is hydrogen or C₁-C₁₀ alkyl and X is CH₂ or one of the following structures

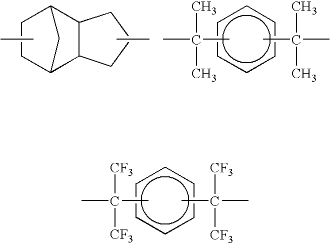

and n is a number from 0 to 20 (examples include XU366 and XU71787.07, commercial products from Vantico);

cyanate esters having the structure: N≡C—O—R⁷—O—C≡N, and

cyanate esters having the structure: N≡C—O—R⁷, in which R⁷ is a non-aromatic hydrocarbon chain with 3 to 12 carbon atoms, which hydrocarbon chain may be optionally partially or fully fluorinated.

Suitable maleimide resins include those having the generic structure

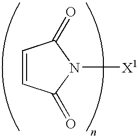

n which n is 1 to 3 and X¹ is an aliphatic or aromatic group. Exemplary X¹ entities include, poly(butadienes), poly(carbonates), poly(urethanes), poly(ethers), poly(esters), simple hydrocarbons, and simple hydrocarbons containing functionalities such as carbonyl, carboxyl, amide, carbamate, urea, ester, or ether. These types of resins are commercially available and can be obtained, for example, from Dainippon Ink and Chemical, Inc.

Additional suitable maleimide resins include, but are not limited to, solid aromatic bismaleimide (BMI) resins, particularly those having the structure

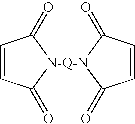

in which Q is an aromatic group.

Exemplary aromatic groups include

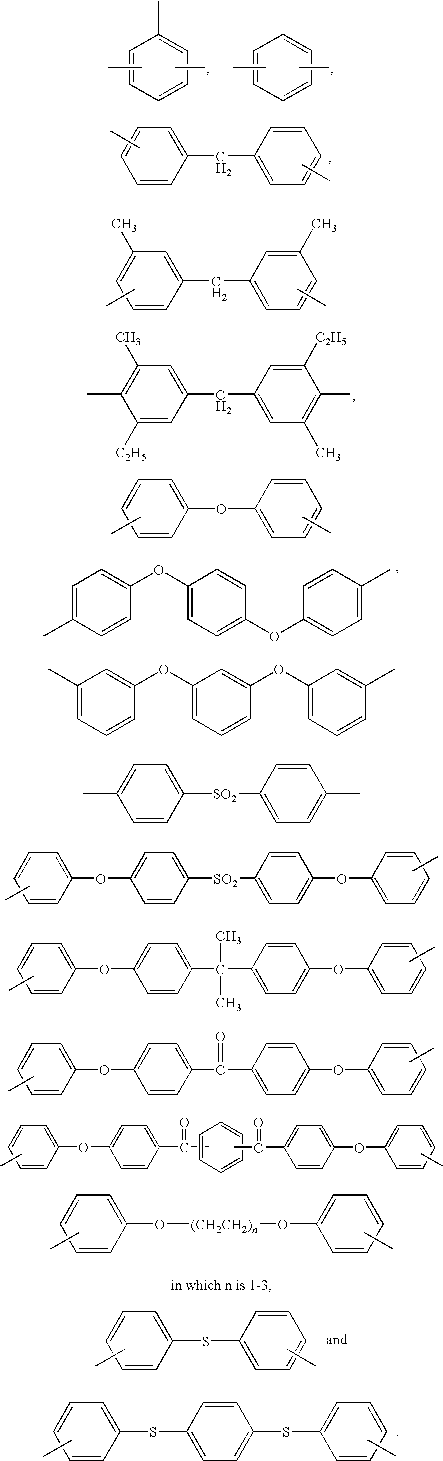

Bismaleimide resins having these Q bridging groups are commercially available, and can be obtained, for example, from Sartomer (USA) or HOS-Technic GmbH (Austria).

Other suitable maleimide resins include the following:

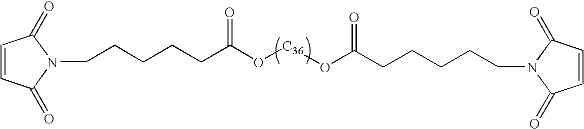

in which C₃₆ represents a linear or branched hydrocarbon chain (with or without cyclic moieties) of 36 carbon atoms;

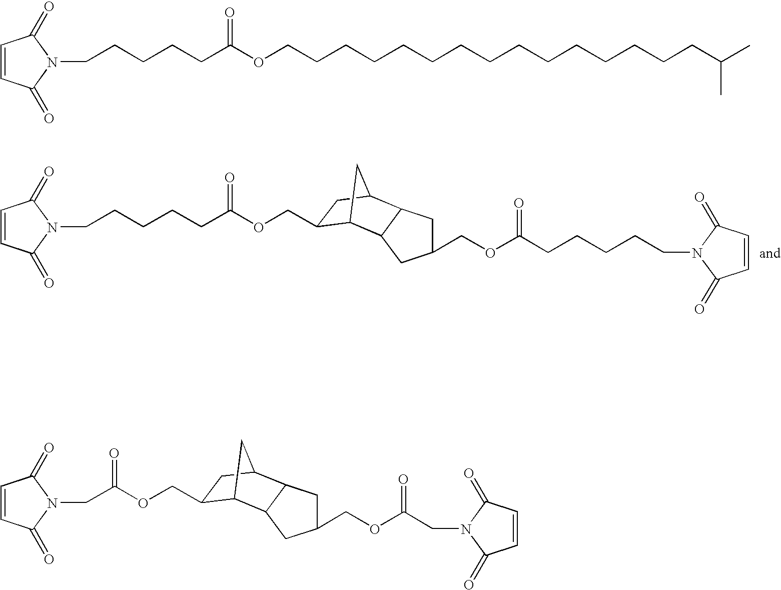

Suitable acrylate and methacrylate resins include those having the generic structure

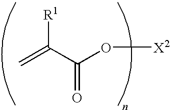

in which n is 1 to 6, R¹ is —H or —CH₃. and X² is an aromatic or aliphatic group. Exemplary X² entities include poly(butadienes), poly-(carbonates), poly(urethanes), poly(ethers), poly(esters), simple hydrocarbons, and simple hydrocarbons containing functionalities such as carbonyl, carboxyl, amide, carbamate, urea, ester, or ether. Commercially available materials include butyl (meth)acrylate, isobutyl (meth)acrylate, 2-ethyl hexyl (meth)acrylate, isodecyl (meth)acrylate, n-lauryl (meth)acrylate, alkyl (meth)-acrylate, tridecyl(meth)-acrylate, n-stearyl (meth)acrylate, cyclohexyl(meth)acrylate, tetrahydrofurfuryl-(meth)acrylate, 2-phenoxy ethyl(meth)-acrylate, isobornyl(meth)acrylate, 1,4-butanediol di(meth)acrylate, 1,6-hexanediol di(meth)acrylate, 1,9-nonandiol di(meth)acrylate, perfluorooctylethyl (meth)acrylate, 1,10 decandiol di(meth)-acrylate, nonylphenol polypropoxylate (meth)acrylate, and polypentoxylate tetrahydrofurfuryl acrylate, available from Kyoeisha Chemical Co., LTD; polybutadiene urethane dimethacrylate (CN302, NTX6513) and polybutadiene dimethacrylate (CN301, NTX6039, PRO6270) available from Sartomer Company, Inc; polycarbonate urethane diacrylate (ArtResin UN9200A) available from Negami Chemical Industries Co., LTD; acrylated aliphatic urethane oligomers (Ebecryl 230, 264, 265, 270, 284, 4830, 4833, 4834, 4835, 4866, 4881, 4883, 8402, 8800-20R, 8803, 8804) available from Radcure Specialities, Inc; polyester acrylate oligomers (Ebecryl 657, 770, 810, 830, 1657, 1810, 1830) available from Radcure Specialities, Inc.; and epoxy acrylate resins (CN104, 111, 112, 115, 116, 117, 118, 119, 120, 124, 136) available from Sartomer Company, Inc. In one embodiment the acrylate resins are selected from the group consisting of isobornyl acrylate, isobornyl methacrylate, lauryl acrylate, lauryl methacrylate, poly(butadiene) with acrylate functionality and poly(butadiene) with methacrylate functionality.

Suitable vinyl ether resins are any containing vinyl ether functionality and include poly(butadienes), poly(carbonates), poly(urethanes), poly(ethers), poly(esters), simple hydrocarbons, and simple hydrocarbons containing functionalities such as carbonyl, carboxyl, amide, carbamate, urea, ester, or ether. Commercially available resins include cyclohexanedimethanol divinylether, dodecylvinylether, cyclohexyl vinylether, 2-ethylhexyl vinylether, dipropyleneglycol divinylether, hexanediol divinylether, octadecylvinylether, and butandiol divinylether available from International Speciality Products (ISP); Vectomer 4010, 4020, 4030, 4040, 4051, 4210, 4220, 4230, 4060, 5015 available from Sigma-Aldrich, Inc.

The resin composition may also include a curing agent for any of the resins present. Whether or not the curing agent or catalyst is added to the resin system before or after the cavitation process is at the discretion of the practitioner. In typical systems, the curing agent will be added after the cavitation operation to prevent action of the catalyst and advancement of the resin system. However, it may be desirable in some circumstances to mix the curing agent with the resin and filler, and this option is open to the practitioner.

The curing agent (or catalyst) can be either a free radical initiator or an ionic initiator (either cationic or anionic), depending on whether a radical or ionic curing resin is chosen. The type and amount of curing agent required for a particular resin system can be determined by those skilled in the art. In some cases, it may be desirable to use more than one type of cure, for example, both ionic and free radical initiation, in which case both free radical cure and ionic cure resins can be used in the composition. Such a composition would permit, for example, the curing process to be started by cationic initiation using UV irradiation, and in a later processing step, to be completed by free radical initiation upon the application of heat

Fillers for these resin systems can be any that are effective and useful. Examples of suitable nonconductive fillers include alumina, aluminum hydroxide, silica, fused silica, fumed silica, vermiculite, mica, wollastonite, calcium carbonate, titania, sand, glass, barium sulfate, zirconium, carbon black, organic fillers, and halogenated ethylene polymers, such as, tetrafluoroethylene, trifluoroethylene, vinylidene fluoride, vinyl fluoride, vinylidene chloride, and vinyl chloride. Examples of suitable conductive fillers include carbon black, graphite, gold, silver, copper, platinum, palladium, nickel, aluminum, silicon carbide, boron nitride, diamond, and alumina. Included with the metal fillers are alloys of any metals, solders of any composition, and fillers with a core of one type of compound or composition (metallic, inorganic, or organic, coated with another type of compound of composition (metallic, inorganic, or organic).

The filler particles may be of any appropriate size ranging from nano size to several mm. The choice of such size for any particular end use is within the expertise of one skilled in the art. Filler may be present in an amount from 10 to 90% by weight of the total composition. More than one filler type may be used in a composition and the fillers may or may not be surface treated. Appropriate filler sizes can be determined by the practitioner for the end use application.

### EXAMPLES

The cavitation number is a dimensionless number representing the ratio of a fluid's cohesive energy (pressure) to its kinetic energy. The simple interpretation of this ratio is how much energy is needed to tear a cavity in a fluid generating a vapor bubble (the cohesive energy) relative to the amount of kinetic energy the fluid possesses. In this framework when the kinetic energy is equal to the cohesive energy, the fluid ruptures, that is, cavitation occurs. A fluid with a cavitation number in the vicinity of unity theoretically possesses probability of cavitation. A material with a cavitation number larger than unity means that the cohesive energy is larger than the kinetic energy, and theoretically cavitation is more difficult to obtain. A material with a cavitation number less than unity means the kinetic energy dominates the cohesive energy, and theoretically possesses enhanced probability of cavitation. In practice, water and other commonly studied small molecule liquids exhibit the inception of cavitation when the cavitation number is between 2 and 0.8.

It is not generally known at what cavitation number oligomeric resins are expected to cavitate. To achieve cavitation in practice for a highly filled, viscous, oligomeric resin with near zero vapor pressure is not a trivial matter. The inventors determined on a combination of two basic approaches: make the material less cohesive and impart greater kinetic energy by reduction of the hydrostatic pressure (P) or increased velocity (V) of the material to be cavitated. Considering the case where a fluid flowing in a pipe is forced to flow through a constriction, there will be both an increase in velocity and pressure drop as the fluid passes through the constriction. The upstream, downstream pressures and the associated velocities can be modeled using the Bernoulli equation.

The following examples all had cavitation numbers approximating 0.1, indicating that cavitation most likely occurred.

### Example 1

### Processing of Silver Filled Resins Using Cavitation

Two resin formulations containing silver flake were prepared by combining the ingredients in TABLE 1.

TABLE 1
FORMULATION FOR EXAMPLE 1

| | | |
|---|---|---|
| Epiclon N730-A Dainippon Ink | 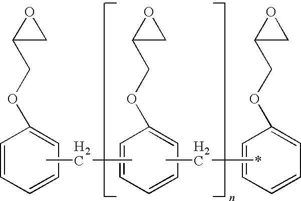 | 11.9 wt % |
| 1,4-Butanediol- diglycidyl ether Aldrich | 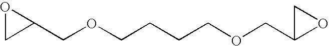 | 8.0 wt % |
| Gamma- glycidylpropyl- trimethoxysilane Witco | 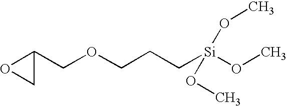 | 0.1 wt % |
| Silver flake | | 80.0 wt % |
| Metalor | | |

Formulation RH viscosity is 0.3 Pa.s at 5 rpm

One formulation was mixed in a conventional planetary mixer with vacuum degassing (purchased from Inoue), and the second mixed by cavitation in a cavitation processor and degassed at 100 Pa for 10 minutes.

The sample mixed in the planetary mixer was mixed for 30 minutes, the first 15 minutes at atmospheric pressure and the second 15 minutes at 100 to 200 Pa, using a blade frequency of 60 Hz.

The sample was mixed in the cavitation processor and the product was collected downstream and passed through the cavitation processor several times. After processing the samples were degassed under 100 Pa for ten minutes.

The viscosity and thixotropic index of the formulations were measured using a Brookfield Cone & Plate Rheometer at the conditions specified in the table. The thixotropic index (TI) is the ratio of the viscosity at 5 rpm to 0.5 rpm. The particle size of the filler was measured by spreading (using a steel doctor-blade) a small amount of the filled composition onto a Hegman Gauge with a gap size from 0 to 50 μm. The results are reported in TABLE 1.1. Comparing the results of EXAMPLE 1 to EXAMPLE 2 it can be seen that the more volatile diluent in EXAMPLE 2 (the isobornyl methacrylate), which increases the resin vapor pressure), compared to the less volatile diluent in EXAMPLE 1 (1,4-butanediol-diglycidyl ether, which does not increase the resin vapor pressure as much), serves to increase the reduction in viscosity.

TABLE 1.1
COMPARISON OF MIXING METHODS

| | Viscosity Measurements | | | |
|---|---|---|---|---|
| | Brookfield Cone & | | | |
| | Plate Rheometer | | | |
| | 25° C. at 5 RPM | | | |
| | TI: ratio of | | Particle Size | |
| | viscosity | | in microns | |
| | at 5:0.5 RPM. | | measured by | |
| | | Thixotropic | Hegman Gauge | |
| Mixing Method | Viscosity Pa · s | Index | Initial | Average |
| Planetary | 9.113 | 6.0 | 12 | 7 |
| Cavitation | 8.260 | 6.5 | 14 | 5 |
| 2 passes | | | | |
| Cavitation | 8.095 | 6.7 | 7 | 5 |
| 4 passes | | | | |
| Cavitation | 7.929 | 6.8 | 12 | 5 |
| 6 passes | | | | |

### Example 2

### Processing of Silver Filled Resin Using Cavitation

Two resin formulations containing silver flake were prepared by combining the ingredients in TABLE 2.

TABLE 2
FORMULATION FOR EXAMPLE 2

| | | |
|---|---|---|
| Bismaleimide Proprietary | 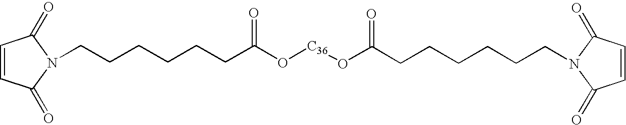 | 9 wt % |
| Isobornyl methacrylate Sartomer | 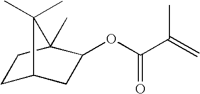 | 6 wt % |
| Silver flake | | 85 wt % |
| Metalor | | |

Formulation RH viscosity is 0.6 Pa.s at 5 rpm

The two formulations were mixed and tested according to the procedures in EXAMPLE 1. The results are reported in TABLE 2.1 and show that with the same filler loading cavitation can reduce the viscosity of the filled resin system, increase the thixotropic index, and reduce average flake size of silver filler.

TABLE 2.1
COMPARISON OF MIXING METHODS

| | Viscosity Measurements | | | |
|---|---|---|---|---|
| | Brookfield Cone & | | | |
| | Plate Rheometer | | | |
| | 25° C. at 5 RPM | | | |
| | TI: ratio of | | Particle Size | |
| | viscosity | | in microns | |
| | at 5:0.5 RPM. | | measured by | |
| | | Thixotropic | Hegman Gauge | |
| Mixing Method | Viscosity Pa · s | Index | Initial | Average |
| Planetary | 14.7 | 5.54 | 22 | 12 |
| Cavitation | 10.9 | 5.39 | 14 | 9 |
| 1 pass | | | | |
| Cavitation | 10.1 | 5.80 | 12 | 5 |
| 2 passes | | | | |
| Cavitation | 10.2 | 6.03 | 12 | 5 |
| 3 passes | | | | |
| Cavitation | 10.0 | 5.85 | 12 | 5 |
| 4 passes | | | | |

### Example 3

### Reduction in Nano Silver Agglomeration within a Resin Composition Using Cavitation

Nano silver fillers have the potential to offer highly improved performance over conventional silver fillers due to their ability to sinter at relatively low temperatures. However, a drawback to their use is that during processing nano silvers can become highly agglomerated and lose the ability to sinter at lower temperatures. This example shows that cavitation processing can be used to de-agglomerate nano particles in resin systems.

Two resin formulations containing nano silver particles were prepared by combining the ingredients in TABLE 3.

TABLE 3
FORMULATION FOR EXAMPLE 3

| | | |
|---|---|---|
| Bismaleimide Proprietary | 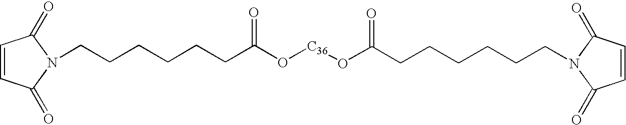 | 30 wt % |
| Isobornyl methacrylate Sartomer | 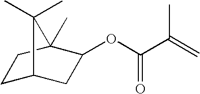 | 20 wt % |
| Nano Silver | | 50 wt % |
| 90% dispersion | | |
| in isopropanol | | |
| Ferro | | |

Formulation RH viscosit is 0.6 Pa.s at 5 rpm

The two formulations were mixed and tested according to the procedures in EXAMPLE 1, except that the sample mixed in the planetary mixer was mixed first for 15 minutes at atmospheric pressure, and for the next 25 minutes at 100-200 Pa. The results show that the viscosity for the sample mixed in the planetary mixer is artificially low due to the presence of very large agglomerated particles in the sample. The results also show that the viscosity increases with cavitation due to the increase in surface area of the nano silver particles as de-aggomeration is achieved.

TABLE 3.1
COMPARISON OF MIXING METHODS

| | Viscosity Measurements | | | |
|---|---|---|---|---|
| | Brookfield Cone & | | | |
| | Plate Rheometer | | | |
| | 25° C. at 5 RPM | | | |
| | TI: ratio of | | Particle Size | |
| | viscosity | | in microns | |
| | at 5:0.5 RPM. | | measured by | |
| | | Thixotropic | Hegman Gauge | |
| Mixing Method | Viscosity Pa · s | Index | Initial | Average |
| Planetary | 2.8 | 9.12 | >100 | >100 |
| Cavitation | 4.6 | 7.85 | 4 | 1 |
| 1 pass | | | | |
| Cavitation | 6.5 | 7.75 | 0 | 0 |
| 2 passes | | | | |
| Cavitation | 7.4 | 7.80 | 0 | 0 |
| 3 passes | | | | |
| Cavitation | 7.2 | 7.75 | 0 | 0 |
| 4 passes | | | | |

### Example 4

### Processing of Copper Filled Resin Using Cavitation

Two resin formulations containing copper particles were prepared by combining the ingredients in Table 4.

TABLE 4
FORMULATION FOR EXAMPLE 4

| | | |
|---|---|---|
| Bismaleimide Proprietary | 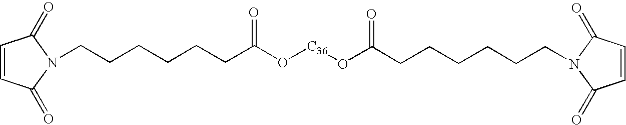 | 15 wt % |
| Isobornyl methacrylate Sartomer | 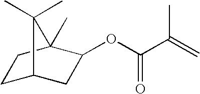 | 10 wt % |
| Copper | | 75 wt % |
| Umicore | | |

The two formulations were mixed and tested according to the procedures in EXAMPLE 1 and the results reported in TABLE 4.1. The results show that with the same filler loading cavitation can reduce the viscosity of the copper filled resin system, increase the thixotropic index, and reduce the average particle/flake size of copper filler.

TABLE 4.1
COMPARISON OF MIXING METHODS

| | Viscosity Measurements | | | |
|---|---|---|---|---|
| | Brookfield Cone & | | | |
| | Plate Rheometer | | | |
| | 25° C. | | | |
| | TI: ratio of | | Particle Size | |
| | viscosity | | in microns | |
| | at 5:0.5 RPM. | | measured by | |
| | Viscosity Pa · s | Thixotropic | Hegman Gauge | |
| Mixing Method | 5 rpm | Index | Initial | Average |
| Planetary | 3.40 | 2.15 | 33 | 19 |
| Cavitation | 2.00 | 2.00 | 22 | 8 |
| 1 pass | | | | |
| Cavitation | 1.60 | 2.63 | 14 | 5 |
| 2 passes | | | | |
| Cavitation | 1.50 | 2.22 | 8 | 2 |
| 3 passes | | | | |
| Cavitation | 1.40 | 2.35 | 4 | 2 |
| 4 passes | | | | |
| Cavitation | 1.30 | 2.50 | 5 | 3 |
| 5 passes | | | | |
| Cavitation | 1.70 | 2.86 | 7 | 3 |
| 6 passes | | | | |

### Example 5

### Processing of Boron Nitride Filled Resin Using Cavitation

A resin composition was prepared to contain 100 parts of diglycidyl ether of bisphenol A (Araldite LY1556 from Huntsman) and 30 parts of reactive mono-functional epoxy diluent (Cardura E10 from Hexion). These compounds were mixed in a standard air-driven propeller mixer until a homogeneous clear solution was observed. From this epoxy blend, 70 parts were mixed with 30 parts of plate-shaped boron nitride (BN) filler from Sintec Keramik GmbH in a double planetary mixer. The boron nitride was added to the mixer in four increments, each increment mixed at low speed for three minutes. After all the boron nitride was added, the mixture was mixed at medium speed for an additional 15 minutes. This BN/epoxy mixture was used as the control resin composition and is identified as sample P.

The BN/epoxy mixture of sample P was divided into four additional parts, each of which was processed further: one using a three-roller mill from Exakt Technologies, Inc. (sample R), one using a dual asymmetric centrifuge speedmixer from Flacktek Inc. (sample S), one using a motor-driven Cowles high shear mixer (sample H), and one using a cavitation processor (sample C). The process conditions are reported in TABLE 5.

After processing, the samples were placed in vacuum jar to remove any entrapped air. Viscosity measurements were done with a rheometer operated at room temperature using 2 cm parallel-plate geometry. Viscosity at shear rate 1.5 s⁻¹ and 15 s⁻¹ were recorded and the shear thinning index (or thixotropic index) calculated as the viscosity ratio of those two (1.5/15). The particle size was measured by a Hegman Gauge as in EXAMPLE 1. The results are reported in TABLE 5.

TABLE 5
COMPARISON OF MIXING METHODS

| | | Viscosity (Pa-s) | | | | |
|---|---|---|---|---|---|---|
| Sample and | | | | Thixo | Viscosity | Hegman |
| Process | Process | | | Index | Percent | Guage |
| Method | Conditions | 1.5 s⁻¹ | 15 s⁻¹ | 1.5/15 | change | μm |
| P (control) | Medium | 284 | 85 | 3.4 | 0 | 10, 6, 6, 6 |
| Planetary | speed 16 | | | | | |
| mixer low | minutes | | | | | |
| shear | | | | | | |
| R | 25μ gap | 152 | 39 | 3.9 | −53 | not |
| 3-Roller Mill | 5 cycles | | | | | measured. |
| | 10μ gap | 155 | 39 | 4.0 | −54 | not |
| | 5 cycles | | | | | measured. |
| | 10μ gap | 141 | 35 | 4.0 | −58 | 19, 6, 6 |
| | 10 cycles | | | | | |
| S | 3000 rpm | 236 | 66 | 3.6 | −22 | not |
| Speed- | 1 minute | | | | | measured |
| Mixer | 3000 rpm | 228 | 64 | 3.6 | −24 | 8, 6, 6, 6, 6, 6 |
| Centrifuge | 5 minutes | | | | | |
| H | 2000 rpm | 219 | 61 | 3.6 | −28 | not |
| High Shear | 10 minutes | | | | | measured |
| Mixer | 2000 rpm | 223 | 62 | 3.6 | −26 | 20, 6, 6, 6 |
| | 30 minutes | | | | | |
| C | 5 cycles | 103 | 26 | 3.9 | −69 | not |
| Cavitation | | | | | | measured |
| processor | 10 cycles | 81 | 21 | 3.9 | −76 | 6, 6 |

To further characterize the aggregate size and distribution, the samples were diluted with bisphenol A epoxy to reduce the boron nitride loading from 30 wt % to 3 wt %. The boron nitride aggregates from these diluted samples were scanned using an Olympus Transmitted Optical Microscope. The aggregate size and size distribution of each sample from various processing conditions are analyzed from 10 recorded micrographs and the results in terms of volume fraction distribution are tabulated in TABLE 5.1.

The data in TABLE 5.1 indicate that cavitation sample C and the three-roller mill sample R have smaller aggregate size boron nitride filler particles compared to the other samples. In terms of aggregate size distribution, cavitation sample C is narrower than the 3-roller mill sample R, having a peak at 20 μm compared to a broader distribution, 15 to 40μ, from the three-roller mill sample R. Sample C also had the lowest aggregate count for the boron nitride. The aggregate size level seen in TABLE 5.1 is correlated well with the viscosity reduction seen in TABLE 5. Aggregate size has a significant impact on the hydrodynamic volume, and the smaller the aggregate size, the smaller the hydrodynamic volume, and therefore, the lower the viscosity.

TABLE 5.1
AGGREGATE SIZE ANALYSIS OF BORON NITRIDE AS FILLER
FOR EPOXY RESIN

| Aggregate | Aggregate Volume Fracture Distribution, % | | | | |
|---|---|---|---|---|---|
| Size, μm | Sample C | Sample R | Sample S | Sample H | Sample P |
| 5 | 0 | 0 | 0 | 0 | 0 |
| 10 | 2.0 | 2.7 | 0.3 | 0.2 | 0.2 |
| 15 | 13.7 | 18.8 | 4.6 | 4.6 | 7.0 |
| 20 | 40.8 | 18.5 | 16.9 | 12.7 | 12.1 |
| 25 | 22.3 | 21.7 | 18.0 | 17.2 | 17.4 |
| 30 | 16.0 | 13.7 | 17.1 | 12.2 | 9.1 |
| 35 | 5.2 | 13.1 | 10.2 | 17.8 | 16.3 |
| 40 | 0 | 11.5 | 12.8 | 5.4 | 11.0 |
| 45 | 0 | 0 | 8.6 | 10.5 | 10.4 |
| 50 | 0 | 0 | 0 | 5.0 | 5.0 |
| 55 | 0 | 0 | 0 | 0 | 0 |
| 60 | 0 | 0 | 11.5 | 0 | 0 |
| 65 | 0 | 0 | 0 | 0 | 11.5 |
| 70 | 0 | 0 | 0 | 14.3 | 0 |
| Total % | 100 | 100 | 100 | 100 | 100 |
| Count | 97 | 123 | 114 | 122 | 133 |

### Example 6

### Dispersion of Boron Nitride in Resins with Cavitation

Boron Nitride was dispersed in various resin systems using a Hobart mixer (HBT) or a 4-leaf clover blade (4LC) at 800-900 rpm for 10-15 minutes, after which the samples were processed further in a cavitation processor. The viscosities before and after the cavitation processing are tabulated in TABLE 6. The data show that the viscosity reduction seen in EXAMPLE 5 is repeatable regardless of the initial processing method (that is, planetary mixer vs Hobart mixer). The data further show viscosity reduction of 23% to 88% on various BN/resin combinations.

TABLE 6
VISCOSITY OF BORON NITRIDE FILLED RESINS
BEFORE AND AFTER CAVITATION

| | BN | Initial | Viscosity at 15 s−1, Pa-s | | |
|---|---|---|---|---|---|
| Resins | wt % | Mixer | Control | Cavitation | % change |
| Epoxy | 30 | HBT | 80.4 | 22.0 | −73% |
| Silicone | 26 | HBT | 56.8 | 13.4 | −76% |
| BMI | 22.5 | 4LC | 13.9 | 9.7 | −30% |
| BMI | 30 | 4LC | 8.7 | 3.8 | −56% |
| Acrylic | | | | | |
| Acrylic | 30 | 4LC | 4.0 | 3.1 | −23% |
| Cyanate | 30 | 4LC | 28.2 | 15.6 | −45% |
| Ester | | | | | |
| Phenoxy | 15.1 | 4LC | 77.4 | 9.5 | −88% |
| Co-poly- | 30 | 4LC | 34.9 | 25.5 | −27% |
| ester | | | | | |

The resins used were:

Epoxy: same as EXAMPLE 5
Silicone: blend of silicone resins, vinyl and SiH terminated polydmethylsiloxane (PDMS), obtained from Bayer
BMI (bismaleimide): proprietary

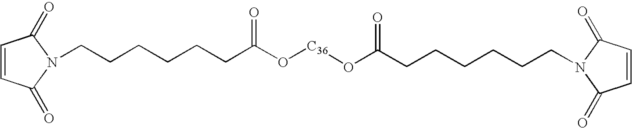

Acrylic: SR206 from Sartomer Company, Inc.
Cyanate ester: Primaset Lecy resin from Lonza, Inc.
Phenoxy dissolved in carbitol acetate: PKHH phenoxy resin from InChem Corp Copolyester dissolved in carbitol acetate: Vitel 3350 resin from Bostik

### Example 7

### Various Fillers in Epoxy Resin Using Cavitation

Various fillers were dispersed in the epoxy resin from EXAMPLE 5 using a Hobart mixer (HBT) or a 4-leaf clover blade (4LC) at 800-900 rpm for 10 to 15 minutes. These samples were further processed in a cavitation processor. The viscosities before and after the cavitation process are tabulated in TABLE 7. The data show viscosity reduction for all the fillers, except for those that are nano-scale. The nano-scale fillers have extremely high surface to volume ratio compared to micron-sized fillers and, therefore, the contribution of surface area dominates the rheological behavior and viscosity increased for those samples. However, the dispersion quality improved.

TABLE 7
Viscosity of Various Fillers in Epoxy Resin Before and After
Cavitation

| | | Fillers | | | | | | |
|---|---|---|---|---|---|---|---|---|
| | | | | | | nano | micro | Carbon |
| | | BN-2 | BN-3 | AlN | SiO2 | Al₂O₃ | Al₂O₃ | nano-tube |
| BN loading, wt % | | 40.0 | 27.3 | 41.3 | 22.5 | 12.9 | 79.6 | 0.267 |
| Initial Mixer | | HBT | HBT | HBT | HBT | 4LC | 4LC | 4LC |
| Viscosity | Control | 27.6 | 20.3 | 4.2 | 1.0 | 1.2 | 13.2 | 5.3 |
| at | Cavitation | 24.0 | 11.4 | 0.9 | 0.9 | 1.2 | 6.8 | 7.0 |
| 15 s−1, Pa-s | % change | −13% | −44% | −79% | −12% | 0% | −48% | 32% |

### Fillers:

BN-2: plate-shaped PT110S BN from Momentive Performance Materials
BN-3: spherical-shaped PTX60 BN from Momentive Performance Materials
AlN: H-grade from Tokuyama Corp.
SiO₂: Silica SO-E1 from Admatechs
Nano Alumina: 50 nm alumina from Sigma-Aldrich
Micro Al₂O₃: rounded alumina from Showa Denka
Carbon nanotube: NC7000 thin multi-wall from Nanocyl

### Example 8

### Additional Filler/Resin Combinations Using Cavitation

Additional filler and resin combinations were processed as in EXAMPLE 5 and their viscosities measured. The results are tabulated in TABLE 8 and show viscosity reductions due to processing by cavitation.

TABLE 8
VISCOSITY OF FILLER AND RESIN COMBINATIONS
BEFORE AND AFTER CAVITATION

| | | Resin | | | |
|---|---|---|---|---|---|
| | | Epoxy2 | Silicone | Silicone | BMI |
| Filler | | Ag | BN-2 | Al + ZnO | SiO₂-2 |
| Filler loading, wt % | | 80.0 | 18.1 | 52.9 | 30.1 |
| Initial Mixer | | Planetary | Hobart | Hobart | Hobart |
| Viscosity | Control | 9.1 | 11.1 | 11.2 | 5.1 |
| at | Cavitation | 7.9 | 4.3 | 7.3 | 3.5 |
| 15 s−1, | % change | −13% | −62% | −35% | −31% |
| Pa-s | | | | | |

### Resins:

Epoxy-2: 100/67 blend of Epiclon N730-A and 1,4 butanedioldiglycidyl ether
Silicone: same as EXAMPLE 6
BMI: same as EXAMPLE 6

### Fillers:

Ag: micron-sized Ag flake from Metalor Technologies USA
BN-2: same as example 6
Al: platelet aluminum (Al-101) and spherical aluminum (AI-104) from Atlantic Engineering Equipment
ZnO: zinc oxide (Zn-601) powders from Atlantic Engineering Equipment
SiO2-2: silica SE1050-SQ from Admatechs

### Example 9

### Boron Nitride Loading Study

The same boron nitride/epoxy system prepared in EXAMPLE 5 was studied further by varying the boron nitride (BN) loading. The samples were prepared according to the following procedural steps:

Step 1 25 wt % BN was weighed and mixed with epoxy using a 4-leaf clover blade at 900 rpm for 10 minutes.
Step 2 The filled resin was processed as in EXAMPLE 5 for 5 cavitation cycles.
Step 3 Additional BN was added to the cavitation-processed resin system to increase loading to 30 wt %. This was mixed again as in step 1.
Step 4 This 30 wt % boron nitride filled resin was processed with cavitation as in step 2.
Steps 3 and 4 were repeated to prepare 35 wt % and 40 wt % boron nitride loading resins that were passed through five cavitation cycles.

Control samples with the same boron nitride loadings as in the cavitated samples were prepared by mixing in a centrifuge speedmixer. The viscosity was measured as in the previous examples. The resins were mixed with an amine-based curative and cured in a 1 mm thick circle-shaped mold at 150° C. for 30 minutes. The thermal conductivity of these cured disks were measured at 25° C. with a Laser Flash instrument from Netzsch Instruments, Inc. The viscosity and thermal conductivity data are tabulated in TABLE 9.

TABLE 9
EFFECT OF MIXING METHOD ON BN LOADING
VISCOSITY AND THERMAL CONDUCTIVITY

| Control - speedmixer | | | Cavitation - 5 cycles | | |
|---|---|---|---|---|---|
| | Viscoity @ | Thermal | | Viscosity | Thermal |
| wt % | 15 s−1 | Conductivity | wt % | at 15 s−1 | Conductivity |
| BN | Pa-s | W/mK | BN | Pa-s | W/mK |
| 14.9 | 1.8 | 0.49 | — | — | — |
| 18.2 | 3.7 | 0.73 | — | — | — |
| 19.9 | 6.2 | 0.84 | — | — | — |
| 24.9 | 22.1 | 1.14 | 25.0 | 11.7 | 1.07 |
| 30.1 | 80.4 | 1.25 | 30.0 | 22 | 1.25 |
| 34.9 | 163.2 | 1.702 | 35.0 | 47 | 1.68 |
| 40 | not | — | 40.0 | 88.1 | 1.84 |
| | measurable | | | | |

For a given loading of filler, thermal conductivity is approximately the same for both processing methods. The advantage of the cavitation methodology is that for a given filler loading, processability can be improved by a reduction in viscosity. Therefore, for a given viscosity, improved thermal conductivity (by increased loading of filler) can be achieved, or, for a given thermal conductivity a better processability (by reduction in viscosity) can be achieved.

### UTILITY

In several embodiments, this invention is directed to compositions or thick films prepared by the addition of filler particles into resins using cavitation. The filled compositions can be electrically or thermally conductive by the addition of conductive particles, or insulative by the addition of non-conductive fillers, or rheologically modified by the addition of particles with specific properties.

Electrically and thermally conductive fillers include silver, copper, copper alloys, silver coated copper, silver coated fibers, gold, palladium, platinum, nickel, gold or silver coated nickel, carbon black, carbon fiber, graphite, aluminum, silver coated aluminum, indium tix oxide, metallic coated glass spheres, solder (lead and lead-free based solders), indium tin oxide (ITO), antimony doped tin oxide, carbon nanotubes (CNT), conductive oxides, conductive polymer (CP) particles, CP-coated particles, metal-coated polymeric particles, low melting metal and alloy particles (In, In—Sn, Sn—Bi), nano silver, nano copper, nano nickel, other nano-silver coated fillers, CNT-coated fillers, and graphite-coated fillers, high temperature metal and alloy (e.g. Ag/Pd, Sn/Au, Sn/Ag), nano-Ag coated fillers, CNT-coated fillers, graphite-coated fillers, and mixtures thereof.

Other types of fillers for use in adhesives, coatings, and encapsulants are added for their properties or to affect rheology. Examples of such fillers include fused silica, amorphous silica, ground quartz, silver, aluminum nitride, boron nitride, alumina, glass, zinc oxide, zirconium oxide, barium titanate, zirconium silicate, carbon fiber, carbon nanotubes, Fe—Ni alloy, zirconium tungstate, fumed silica, bentonite, laponite, needle shaped zinc, silicon, semiconductive doped oxides such as zinc tin oxide, polybutadiene, various rubbers, polyethylene, core-shell rubber particles, silicone rubber, spacer beads: polystyrene, polydivinylbenzene, latex particles, fluoropolymer particles including polytetrafluoroethylene (PTFE), polyvinylidene fluoride (PVDF), polyvinylidene chloride, polychlorotrifluoroethyelen, layered silicates, montmorillonite, vermiculite, mica, synthetic mica, talc, calcium sulfate, zeolite, calcium oxide, silica gel, magnesium sulfate, sodium sulfate, calcium chloride, magnesium chloride, barium oxide, potassium oxide, calcium hydride, P205, amines, imidazoles, peroxide, azo compounds, metal compounds and anhydrides, powdered Fe, copper particles, clay, molecular sieves, carbon black, graphite, silica, silicon carbide, silicon nitride and tungsten carbide, polymer coated silica, nanoparticles coated microparticles, polymer particles, low k dielectrics, high k dielectrics, phosphor, doped tin oxide, ITO, ATO, tungsten trioxide and vanadium pentoxide.

Fillers that are thermally conductive and at the same time electrically insulative include alumina, alumina oxide, silica and quartz, mica, talc, hollow glass beads, zinc oxide, magnesium oxide, diamond, aluminum oxide (Al2O3), silicon nitride (Si3N4), boron nitride (BN), silicon carbide (SiC), aluminum nitride (AlN), TiB2, GaP, AlP, GaN, BaS, BeS, BP, and mixtures thereof.

Suitable resins include all those thermoplastic and thermoset resins that are used in adhesives, coatings, and encapsulants. Exemplary resins include polyesters, polyurethanes, polyamides, phenoxy resins, polyacrylates, vinyl-containing resins, epoxies, acrylics and acrylates, silicones, maleimides, and cyanate esters, silicones.

Examples of uses for electrically conductive resins or thick films include the manufacture of internal electrodes in multi-layer capacitors; interconnections in multi-chip components; conductive lines in auto defoggers/deicers, photovoltaic modules, resistors, inductors, antennas and membrane switches; electromagnetic impulse shielding (such as in cellular telephones), thermally conductive films; light reflecting films; conducting adhesives; electrical interconnections within electronic products; grids or conductive tracks for collecting or distributing electrical current or heating.

Areas in which electrically conductive compositions may be used include die attach, component attach, multilayered ceramic capacitors (MLCC), conductive tracks, radiofrequency identification devices (RFID), polymer thick films, electromagnetic impulse (EMI) shielding, static charge dissipation, photo voltaics, display transparent electrodes, conductive traces for heating applications, conductive inks, printable electronic applications; surface coatings for windows in houses, automobiles, or appliances to reflect solar heat and to aid cooling or to reflect infrared radiation; thermal interface materials; and transparent electrically conductive compositions. conductive adhesives, coatings, or encapsulants

Electromagnetic shielding to prevent unwanted interference between electronic components is important in many communication and computer products in which the operation of electronic components in close proximity to one another could be detrimental. For example, a film made from a transparent composition of this invention may be interposed between the receiver and/or transmitter and other electronic components in a cellular telephone to prevent fields induced by the electronic components from distorting or corrupting radio signals.

Transparent electrically conductive compositions are those that pass light in the wavelength region sensitive to the human eye while rejecting light in the infrared region. For this application the light transparency of the transparent electrically conductive compositions is due to the particle size of the filler particles being less than 0.38 μm. Such transparent electrically conductive compositions have a relatively high transmittance over the entire visible light region while also possessing the ability to reflect light of longer wavelengths than visible light. Transparent electrically conductive compositions may be UV or light curable.

In addition to the above applications, electrically conductive compositions comprising filler particles may be used for disinfecting or sterilizing substrates; catalyzing chemical reactions; chemically or mechanically polishing surfaces; and for removing static charge from substrates.

The inventive compositions may also be used in coating and adhesive compositions that typically include filler particles dispersed in a liquid vehicle. These compositions typically include a binder, a thickener or resin, and a wetting agent. The relative quantities of binders, thickeners, solvents, stabilizing agents and wetting agents are known in the art and will vary depending upon the specific application. The binder can be, for example, a curable organic resin. The thickener imparts a desired viscosity and acts also as a binding agent. Examples of thickeners include ethyl cellulose and polyvinyl acetates. The solvent assists in mixing of the components into a homogenous paste and evaporates rapidly upon application of the film. Usually the solvent is a volatile liquid such as, for example, methanol or ethanol.

Coating and adhesive compositions for electronic applications usually have strict thickness requirements. There is a growing need to achieve thinner and thinner bondline thickness for various die attach and component attach adhesives. Fillers prepared by conventional methods are often highly aggregated. If such fillers are used in coating and adhesive compositions without proper dispersion and deagglomeration, the large aggregate size will result in thick and uncontrolled bondline thickness. Filled coating and adhesive compositions prepared by cavitation are particularly useful for achieving thin film and adhesive bondlines.

The coating and adhesive compositions of the present invention may be used to make thick films with highly definable edges. This is particularly important when it is desirable to reduce device thickness, such as with multi-layer capacitors, or to provide an increased density of conductive lines, such as in multi-chip modules in semiconductor packages.

Sprayable coating and adhesive compositions can also be produced by cavitation. The sprayable coating and adhesive compositions can be applied by spraying onto, for example, resistive or dielectric substrates followed by removing most of the solvent in a low temperature drying step at ambient or slightly higher temperature. After low temperature drying the filler particles are temporarily but firmly adhered to the substrate. In a subsequent, optional process step, the dried part may be heated to sinter the components of the composition and permanently attach the filler to the substrate.

The inventive compositions may also be used as thermal interface materials. With the development of more sophisticated and smaller electronic devices, the problems associated with the generation of relatively extreme temperatures by the components of such devices has become more acute. Indeed, the amount of heat generated from certain electronic components increases with higher performance and smaller component size. In addition, those components that are heat sources are likely to be adjacent to, and adversely affecting, other components. Particularly, it becomes very difficult to cool the components in sealed electronic equipment where the heat generated by the heat source is concentrated within the device with potentially damaging results, and external surfaces can become heated and may be uncomfortable or even dangerous to the user. The increasingly wide range of environmental conditions, including temperature extremes, in which electronic devices are expected to operate, exacerbates the effects of excessive heat. In this context, thermal management becomes an increasingly important element of the design of electronic products.

Within the electronics industry, one method used to dissipate heat from electronic components is through the use of thermal interface materials such as thermally-conductive compositions. Thermally-conductive compositions can be used in a variety of ways, such as, for example, in the form of thermally-conductive sheets or pads acting as an interface between the surface of the heat-generating device (e.g. memory chip) and an adjacent heat-dissipating device (e.g. heat sink or cold plate).

Thermal interface materials are placed on the external surface of an electrical component to conduct heat away from the electrical component to the air or to a substrate on which the component is mounted. Thermal interface materials are often applied as a thermally conductive adhesive between the component and a board or other substrate on which the component is mounted. In general, thermal interface materials are used to improve the heat flux between hot devices/substrates and cold sinks/spreaders.

Thermally-conductive materials are made frequently from compositions comprising a thermosetting silicone elastomer and thermally-conductive filler material. Prior art examples of such thermally-conductive materials and their uses are described in: U.S. Pat. No. 5,060,114 (Feinberg et. al.); U.S. Pat. No. 5,011,870 (Peterson); and U.S. Pat. No. 5,945,217 (Hanrahan).

Within the realm of thermal materials, most activity in the past decade has revolved around increased filler loading and particle alignment, as both provide a least resistance path for phonon transport. However, increasing particle loading without sacrificing other performance characteristics (e.g. adhesion, flexibility) or application requirements (e.g. paste viscosity, handling characteristics of film materials) is difficult. Cavitation allows an increase in filler loading and alignment in thermal interface compositions, but still allows the composition to be dispersed easily.

Prior art thermal interface compositions consist generally of fillers dispersed in liquid resins or resins with solvent. If a high level of filler is used with these compositions, the result is high conductivity and poor processability, and, conversely, if a low amount of filler is used the thermal conductivity is poor.

Thermal interface compositions comprising filler particles modified and/or mixed and/or dispersed by cavitation avoid most of the problems of the prior art. Unlike prior art thermal interface compositions, the compositions of this invention are unique in exhibiting low viscosity and high dispersion properties while maintaining flexibility and handleability at high filler particle loading. The filler particles of this invention provide the thermal interface compositions with higher filler loading for better thermal conductivity, while maintain good processability for dispensing and coating, and they enable thinner bonding thickness through fully de-agglomerated dispersion quality

In general, the thermal interface compositions of the present invention have many advantageous features over known thermal interface compositions, including improved thermal conductivity properties, including higher conductivity and improved rheology for a given conductivity. Moreover, the thermal interface compositions can, if required, also possess electrical conductivity. In addition, the thermal interface compositions of this invention have high mechanical strength, due in part to there being less agglomeration-related defects, and maintain high thermal conductivity over repeated thermal heating and cooling cycles.

Any particulate solids capable of providing the thermal interface compositions with the desired thermal conductivity may be utilized as filler particles suitable for use in the present invention. Although electrically conductive filler particles are suitable for use with this invention, such particles are preferably electrically insulative as well as thermally-conductive. The thermal interface compositions of this invention may also comprise mixtures of electrically conductive and electrically insulative filler particles.

The filler particles are to be included in the thermal interface compositions in an amount sufficient to provide the desired thermoconductivity. Preferably, the filler particles are included in amount of from about 5% by volume to about 90% by volume of the thermal interface compositions.

The filler particles for use with the thermal interface compositions of this invention preferably have a weight average size, for most applications, in a range having a lower limit of about 0.001 μm, more preferably a lower limit of about 0.01 μm; and have an upper limit of about 100 μm, more preferably an upper limit of about 50 μm and even more preferably about 20 μm.

Non-solid conductivity promoters such as ionic liquids, liquid organometallic compounds, liquid alloys and conductive polymers may be added to the thermal interface compositions of this invention as required. Additives such as antioxidants, corrosion inhibitors, plasticizers, stabilizers, dispersing agents, coloring agents, tackifiers, adhesives, and the like may be added to the thermal interface compositions in accordance with this invention.

The thermal interface compositions of this invention may take any form such as a pad, grease, gel, paste, coating, film, and combinations thereof. Such compositions may be adhesive or non-adhesive in nature.

In preparing the thermal interface compositions of this invention, the filler particles may be intimately mixed, at any time as the processing requires, with the other ingredients of the thermal interface compositions by using one or more cavitation methods and/or other techniques known in the art. The loading of the filler particles in the matrix imparts thermal conductivity to the thermal interface compositions.

An example of one method of forming a thermal interface composition as a film or coating, is to combine and thoroughly mix the ingredients while slowly adding a solvent until a liquid having a smooth texture is achieved. The material is then cast onto a release sheet such as a piece of glass, MYLAR® film or coated paper, or on to a support layer and heated to drive off the solvent and form the thermal interface composition.

Typical applications for the thermal interface compositions of this invention include: semiconductor assembly wherein the thermal interface compositions may be used for semiconductor die attach in powder electronics, microwave electronics and opto electronics, or used between semiconductor die and lid (e.g. TIM1 in CPU), or used for thermal vias in semiconductor dies; component and printed wiring board (PWB) assembly where the thermal interface compositions may be utilized for attaching lid into electronic modules, attaching PWB to a heat sink, and for thermal vias on PWB/low-temperature co-fired ceramic (LTCC) substrates; circuit assembly in which the thermal interface compositions may be used between printed circuit boards (PCB) and electronics components or devices (for example, as conductive adhesives for component attachment or as thermal greases for powder amplifier attachment to chassis), and for thermal vias and used between the top of an electronic device on PCB and a heat sink; system assembly where the thermal interface compositions may be used for assembling PCB to a heat sink (or chassis), and for assembling photovoltaic cell modules to heat sinks; equipment assembly in which the thermal interface compositions may be used in assembling electronic systems/modules to equipment housing; and in general for semiconductor assembly, circuit assembly, component assembly, photovoltaic assembly, organic light emitting diode (OLED) assembly, LCD assembly, opto electronic assembly, industrial power device assembly.

The compositions produced by cavitation according to this invention may be applied to various substrates by coating techniques well-known to those of ordinary skill in the art, for example, spraying, brushing, dipping, rolling or screen printing. Such known processes include pyrolysis, powder coating, vapor deposition, cathode sputtering, ion plating, ink-jet printing, litho printing, electrostatic transfer printing, thermal transfer printing, stencil printing, screen printing, jet printing, spray printing, gravure printing, flexographic printing, syringe dispersion and the like. For some applications, cathode sputtering and vapor deposition are often preferred in view of the uniformity of structure and thickness that can be obtained. The thickness of the compositions can be selected to provide the required conductivity or insulative properties. For other applications, spraying is a preferred method because it is fast and it permits the laying down of uniform, thin layers on very intricately shaped parts.

Compositions produced by cavitation avoid the problems of the prior art with regard to spraying as a method for deposition. While it is desirable to have sprayable coating and adhesive compositions, for example silver coating composition based on an aqueous vehicle, it had been difficult to formulate such compositions. Poorly dispersed filler particles do not spray uniformly and, as a result, produce an irregular coating on the substrate. Also, when the concentration of filler particles in the composition is high, the viscosity rises and adversely affects spraying performance. There also may be a tendency for the filler particles to settle and agglomerate. This is particularly troublesome when attempting to lay down at high speed a specified coating thickness in the least number of spraying applications. Cavitation produced compositions avoid or reduce these problems.

The fillers themselves can have particle sizes in the micron range and in the nano range. Particle sizes in the nano range bring features including high purity; high crystallinity; high density; narrow particle size distribution; spherical morphology; controlled surface chemistry; and reduced agglomeration, and are advantageous for use in electrically conductive compositions and thick films.

The use of hydrodynamic cavitation to prepare nanosize metal-based materials for catalytic, piezoelectric and superconductor use is disclosed in U.S. Pat. No. 6,365,555 (Moser et al), U.S. Pat. No. 5,466,646 (Moser) and U.S. Pat. No. 5,417,956 (Moser).

Conventionally, filler particles have been prepared by various methods such as by co-precipitation in aqueous solutions, electrochemical methods, reverse microemulsion, chemical liquid deposition, photochemical reduction, chemical reduction and UV irradiation. All of these methods have limitations in controlling the particle size and in production on an industrial scale. Metal particles manufactured via conventional methods are commonly in the form of aggregated powder, or they tend to agglomerate irreversibly. Such agglomeration requires a separation process which, as a result, causes a problem in controlling the particle size distribution in a desired range.

Cavitation provides electrically and/or thermally conductive compositions comprising filler particles that can remain in dispersion without permanent agglomeration.

It is preferred that the filler particles of the electrically conductive compositions according to this invention have a narrow particle size distribution, such that the majority of particles are substantially the same size. Preferably, at least about 75 percent by number, more preferably at least about 85 percent by number, even more preferably at least about 90 percent by number and most preferably at least about 95 percent by number of the nanoparticles are smaller than twice the number average particle size. Particle sizes typically are in the range of 0.001 μm to 100 μm, with preferred size ranges for different applications.

Specific advantages related to the use of cavitation in producing filled resin compositions include low viscosity dispersions with regular or higher filler loadings, greater filler dispersion uniformity, lower diluent requirement in liquid formulations (such as adhesive formulations), enhanced particle size management, and improved bondline thickness control.

The filled resin compositions according to this invention may be substituted for compositions used in prior art electrically conductive applications without significant modification of the formulation of the compositions. Additionally, as a result of the superior properties of the filler particles of the present invention, electrically conductive compositions manufactured with such filler particles exhibit improved performance over prior art compositions.

Filler particles according to this invention exhibit good dispersibility in electrically conductive compositions due to the narrow particle size distribution of the filler particles and their low degree of agglomeration. When the electrically conductive composition is a film and/or coating, the improved dispersion of the filler particles results in smoother prints and sharper print edges, and the film or coating may extend over a large area or, alternatively, the film and/or coating may be in the form of a narrow line, or pattern of lines. When spraying is used as the method of deposition, the finely dispersed particles do not clog the spray nozzle.

Further, many coating and adhesive compositions, that have high molecular weight resins added to them, also have high viscosities and require the addition of diluents to reduce these viscosities to levels for normal use. Such diluents are often ionically impure, making the coating and adhesive compositions less desirable for use in electronic applications. There is, therefore, an ongoing requirement for high purity, low viscosity coating and adhesive compositions.

Many fillers used in coating and adhesive compositions have beneficial properties, such as high conductivity, low coefficient of thermal expansion (CTE) and high modulus, making it desirable in these compositions to incorporate as much filler as possible. However, because of the highly aggregated structure of fillers prepared by conventional methods, their incorporation into liquid compositions can cause a rapid increase in viscosity. Compositions produced by cavitation avoid this problem.

In certain applications, coating and adhesive compositions may be required to be applied to delicate surfaces with existing structures, such as an electrical circuit. In these applications the coating and adhesive composition needs to be non-abrasive to avoid damage to the underlining structure. However, many fillers produced by conventional methods have very high surface roughness and can cause abrasion and damage to the underlining structure. Compositions produced by cavitation avoid this problem.

Controlled cavitation can modify filler particle morphology (e.g. size, roughness, shape) and to break down particle agglomerates and particle aggregates in a liquid carrier. Compositions containing filler particles produced via this invention possess unexpected and beneficial properties. Such properties include lower viscosity, lower effective volume fraction of filler, higher maximum filler loading, improved dispensing properties of pastes, decreased aspect ratio of fillers, lower surface roughness of fillers, thinner bondlines, smaller droplet sizes or lower surfactant loading (e.g. in emulsions), unique phase morphology of polymer blends, uniform particle dispersion, faster dissolution of particles into liquid monomers or solvents, ability to wet out otherwise non-wetting fillers (e.g. PTFE) with resins, and reduced product abrasiveness.

Due to their small particle size and narrow particle size distribution, the filler particles of the present invention exhibit good dispersibility in coatings and adhesives. In the case of printable adhesives and coatings, improved dispersion results in smoother prints with fewer lump counts and sharper print edges.

Filler particles produced by cavitation may be incorporated into coatings and adhesives to control/reduce coefficient of thermal expansion (CTE), control rheology; to provide barrier properties or act as desiccants or scavengers (e.g. sealant applications); to act as solid curing agents, catalysts or hardeners, anti-corrosion agents, pigments, dispersants, wetting agents, adhesive promoters, conductivity promoters; to provide abrasion resistance; to provide low emissivity; to provide oxide fillers.

Due to the combination of small particle size and narrow particle size distribution, filler particles produced by cavitation may be used in high performance adhesive and coating compositions in smaller quantities than filler particles produced by conventional methods.

The particles may be single-phase or multi-phase, or composite. Multi-phase materials may be in a variety of morphological forms, for example in an intimate mixture of two or more phases or with one phase forming a surface coating over a core including another phase.

What is claimed:

1. A method of producing a filled resin system comprising providing resin and filler, and subjecting the resin and filler to cavitation.

2. A method of changing the rheology of a filled resin system comprising providing a composition comprising resin and filler and subjecting the composition to cavitation.
